(19) United States
(12) Patent Application Publication
(10) Pub. No.: US 2026/0070091 A1
(43) Pub. Date: Mar. 12, 2026

(54) NONCONTACT ANIMAL DIVERTER SYSTEM

(71) Applicant: TARGAN, INC., Raleigh, NC (US)

(72) Inventor: Zebulon Wayne Rouse, Moncure, NC (US)

(73) Assignee: TARGAN, INC., Raleigh, NC (US)

(21) Appl. No.: 19/325,069

(22) Filed: Sep. 10, 2025

Related U.S. Application Data
(60) Provisional application No. 63/693,141, filed on Sep. 10, 2024.

(51) Int. Cl. B07C 5/36; A01K 45/00

(52) U.S. Cl. CPC B07C 5/366; A01K 45/005

(57) ABSTRACT

A system for diverting an object includes air nozzles, a device for positioning a chick on a moving platform, and sensors for determining characteristics of the chick on the moving platform. When the chick is identified as moving down the moving platform, the system determines which path in the processing system the chick should be sorted to. Then air nozzles are configured to divert the chick to the determined path. In this regard, chicks moving through the system are identified, and then air nozzles are activated to blow the chicks to a desired path.

### BACKGROUND

There are essentially three types of poultry that are processed in today's mass production environment: broilers, breeders and layers. The broilers are grown and slaughtered at maturity for human consumption. Breeders are raised to breed broilers or layers, and layers are raised to lay eggs for human and animal consumption. In each case, as chicks hatch, they are quickly processed and moved to the next stage of their life. Day old chicks are vulnerable to disease and infection. Due to the crowded conditions in which chicks hatch and live, any chick born with an abnormality or disease may be in a position to infect a multitude of other chicks in the surrounding area. Thus, for the health of the flock, a system should remove any chick having a disease or malformation that could cause illness to other chicks. Moreover, it is only humane to remove any seriously ill chicks or disabled chicks so that they can be humanely euthanized and disposed of before causing further injury to themselves.

Day old broiler chicks are processed quickly in hatcheries and are swiftly transported to “Growth Out Farms” where they will live and grow to desired weight for consumption. There are two common maladies that afflict some chicks. The first is a failure of the abdominal wall to close after absorption of the yolk sac. In such a case, the chick hatches with an open abdominal cavity. This condition is typically terminal. If left undetected for any length of time, the open wound will become infected, causing severe distress and ultimately the death of the chick. The infection can also spread to other chicks, posing a risk of increased mortality within the flock.

The second affliction is a malformed or disabled leg or foot or malformed beak or eye. Chicks with malformed legs and feet are unable to withstand the rigors of a mass farming environment, get adequate feed, and water in “Growth Out Farm” and consequently never grow as well as their healthy counterparts, leading to a decrease in the overall production performance of the flock. Thus, they should be removed as quickly as possible.

Thus, there is a need to quickly and efficiently inspect day old chicks to determine whether or not they are sufficiently healthy to withstand the rigors of the poultry production environment. In addition, there is a need to quickly and efficiently detect any physical abnormalities in day old chicks so that those with such abnormalities may be separated from the otherwise healthy flock.

Early sex determination of a chick may also be used in poultry production to ensure that the sexes are separated out as soon as possible to ensure efficient investment of appropriate resources. Layer males have little value to the egg-laying industry because only a limited number of breeder males are necessary. The Feed Conversion Ratio (FCR), or cost of feed per weight gained is the main driver for cost of production and rearing males and females separately is advantageous for poultry processing in broilers.

Determining the sex of a day-old chick has been a common practice in the poultry industry since the early 1900's. Manual vent and feather sexing have been used over the years by the industry to separate male and female chicks. Manual handling of chicks is not only unfriendly to chicks, but also increases early mortality in flocks of sexed chicks. Moreover, manual sexing is less accurate, slower, and highly inefficient compared to an automated chick sexing system.

Thus, there is a need to determine the sex, health, and other characteristics of chicks and to sort them using in processing systems.

However, there is no efficient and accurate way of sorting chicks that also preserves the health and wellbeing of the chicks.

### SUMMARY

Aspects to at least some embodiments of the present application relate to systems for diverting objects being moved through a system.

The embodiments described herein include a system for diverting an object (e.g. a chick). The system includes air nozzles, a device for positioning a chick on a moving platform, and sensors for determining characteristics of the chick on the moving platform. When the chick is identified as moving down the moving platform, the system determines which path in the processing system the chick should be sorted to. Then air nozzles are configured to divert the chick to the determined path.

Another embodiment includes a system. The system includes a series of lanes through with the animals are configured to be moved via at least one conveyer in a first direction; at least one air diverter for each of the series of lanes, wherein a first air diverter of the at least one air diverter is associated with a first lane of the series of lanes and is configured to blow air on a first animal with a force to move the first animal horizontally to a first location in a second direction different from the first direction; and a processor configured to detect the first animal traveling on a first conveyer at a position upstream of the first air diverter and to determine a timing for activating the first air diverter.

Another embodiment includes a system of diverting one or more chicks. The system includes: a first diverter that is associated with a first lane, wherein the first lane is configured to move the first chick through the first lane in a first direction, and wherein the first diverter is configured to blow air on a first chick with a force to move the first chick horizontally to a first location in a second direction; a second diverter associated with the first lane and is configured to blow air on the first chick with a force to move the first chick horizontally to a second location in a third direction; and a processor configured to detect the first chick traveling on a first conveyer at a position upstream of the first and second diverters and to determine whether to activate the first diverter or the second diverter and to determine a timing for activating the first diverter or the second diverter.

Another embodiment includes a method of diverting animals. The method includes: moving, via at least one conveyer, animals through a series of lanes in a first direction; detecting, via a processor, a first animal traveling on a first conveyer at a position upstream of a first air diverter; determining, via the processor, a timing for activating the first air diverter of the at least one air diverter, wherein the first air diverter is associated with a first lane of the series of lanes; and blowing air on the first animal with a force to move the first animal horizontally to a first location in a second direction different from the first direction.

The skilled person will appreciate that except where mutually exclusive, a feature described in relation to any one of the above embodiments may be applied mutatis mutandis to any other embodiment.

### BRIEF DESCRIPTION OF THE DRAWINGS

The disclosure will be described with reference to the accompanying drawings, wherein like numbers reference like elements.

FIGS. 1 and 2 are schematics of a processing system for chicks, according to some embodiments.

FIG. 3 is a perspective view of a sorting portion of the processing system according to some embodiments.

FIG. 4 is a top view of the sorting portion of FIG. 3 according to some embodiments.

FIG. 5 is a perspective view of one lane of the sorting portion according to some embodiments.

FIG. 6 is a side view of the lane of the sorting portion of FIG. 5 according to some embodiments.

FIG. 7 is a front view of a lane and illustrates a method of diverting a chick, according to some embodiments.

FIG. 8 is an illustration of the sorting portion with input lanes showing the air nozzles and air nozzle outputs, according to some embodiments.

FIG. 9 is an illustration of the sorting portion with the output lanes as well as showing the air nozzles and air nozzle outputs of the input lanes, according to some embodiments.

FIG. 10 is an illustration of chicks being diverted using air nozzles to blow chicks over a drop off, according to one embodiment.

### DESCRIPTION OF EXEMPLARY EMBODIMENTS

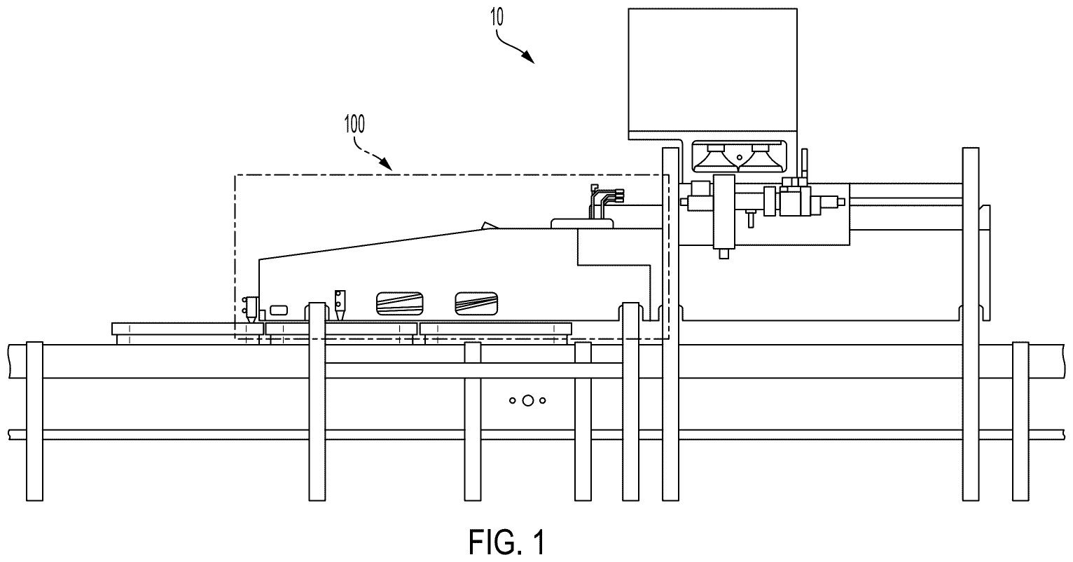

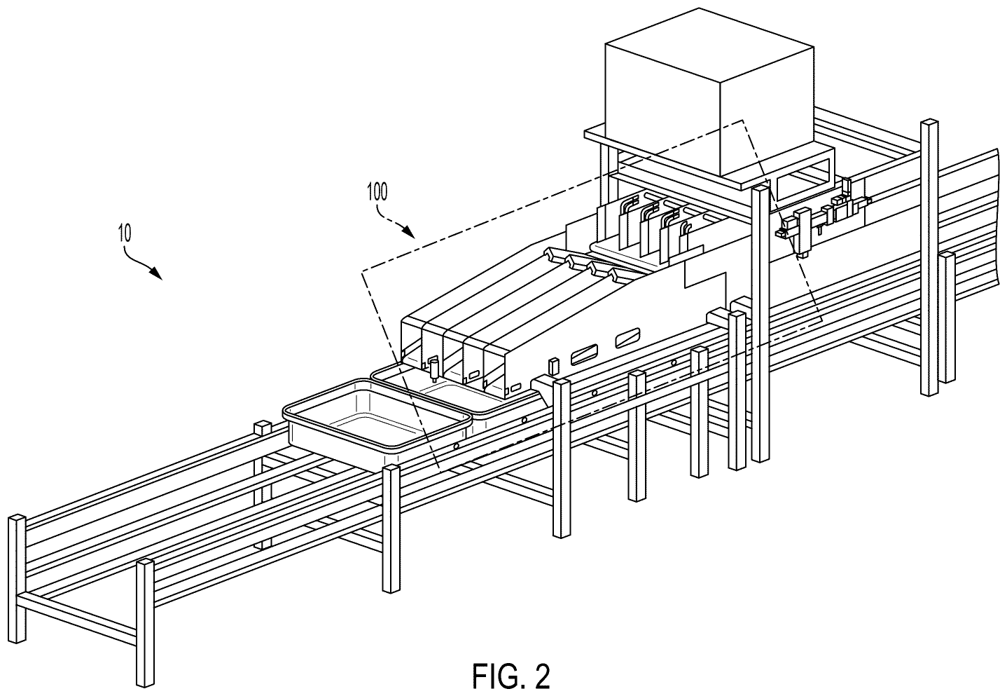

As mentioned above, the present disclosure discloses a processing system that is configured to sort objects. An exemplary processing system 10 is shown in FIGS. 1-2.

In some embodiments, the processing system 10 is configured to process and sort animals, such as day-old chicks. The animals may be any animals, but the present invention should not be limited to animals or a specific type of animal. The present disclosure uses day-old chicks for purposes of describing the invention but the invention could be applied to various other living beings other than chicks. Such exemplary embodiments will now be described.

The processing system 10 includes a section to identify and sort the chicks, as shown as reference numeral 100 in FIGS. 1-2.

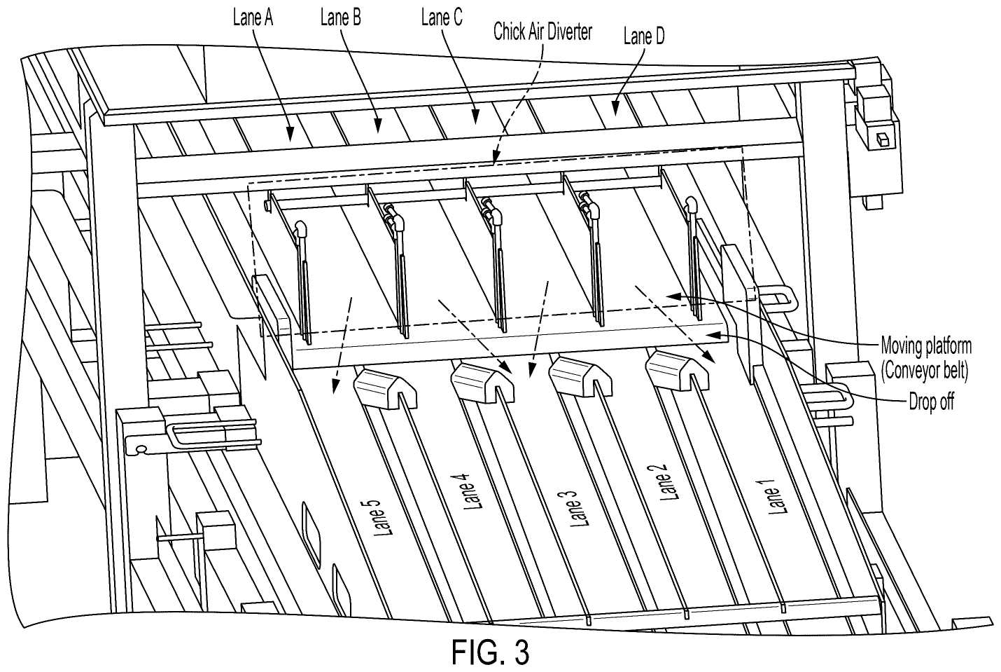

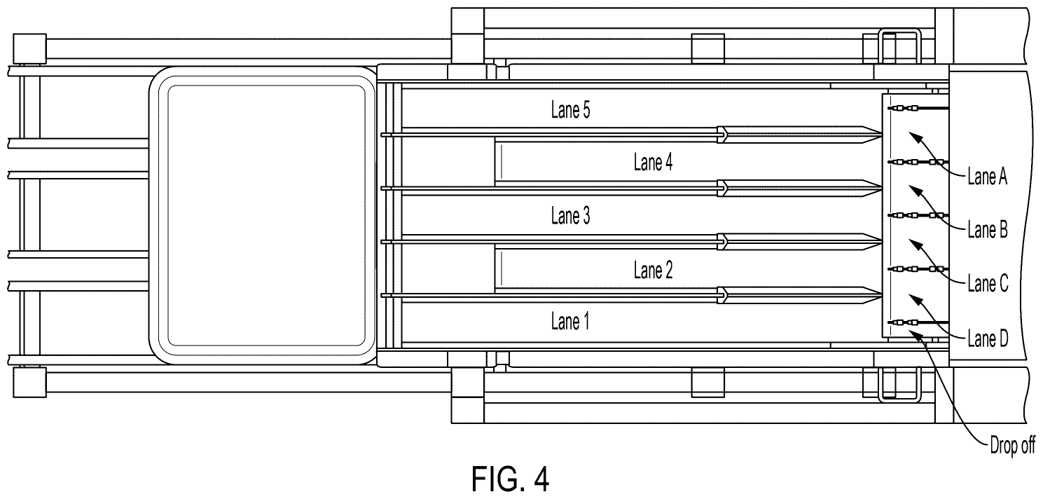

As shown in FIGS. 3-4, the processing system may include input lanes (such as lanes A-D where the chicks travel in), output lanes (lanes 1-5 in FIGS. 3-4), a moving platform, imaging sensors, one or more air nozzles per lane, and sorted output lanes downstream of the air nozzles. Each of these components are discussed in more depth below.

This system is configured to processing a plurality of chicks in a short amount of time where the chicks are delivered to the processing system en masse where the chicks are received on the moving platform.

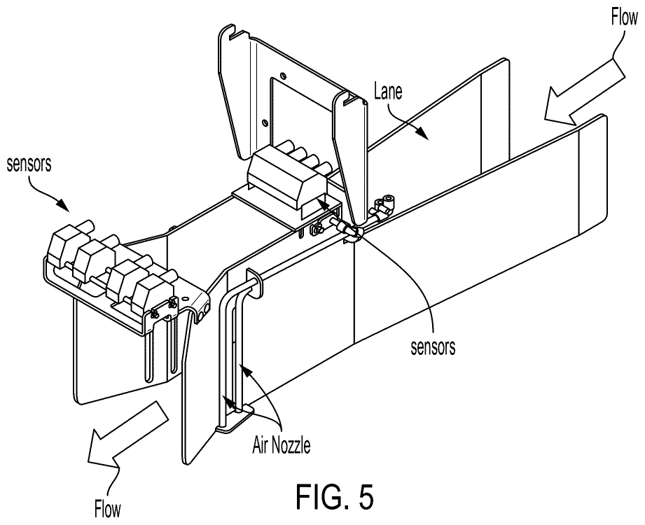

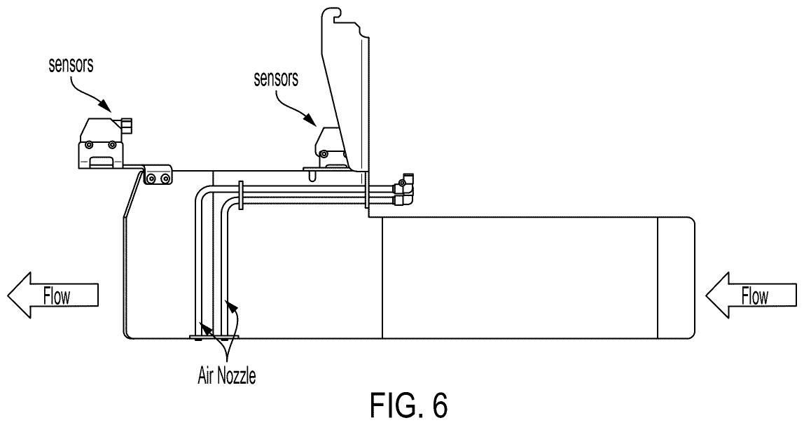

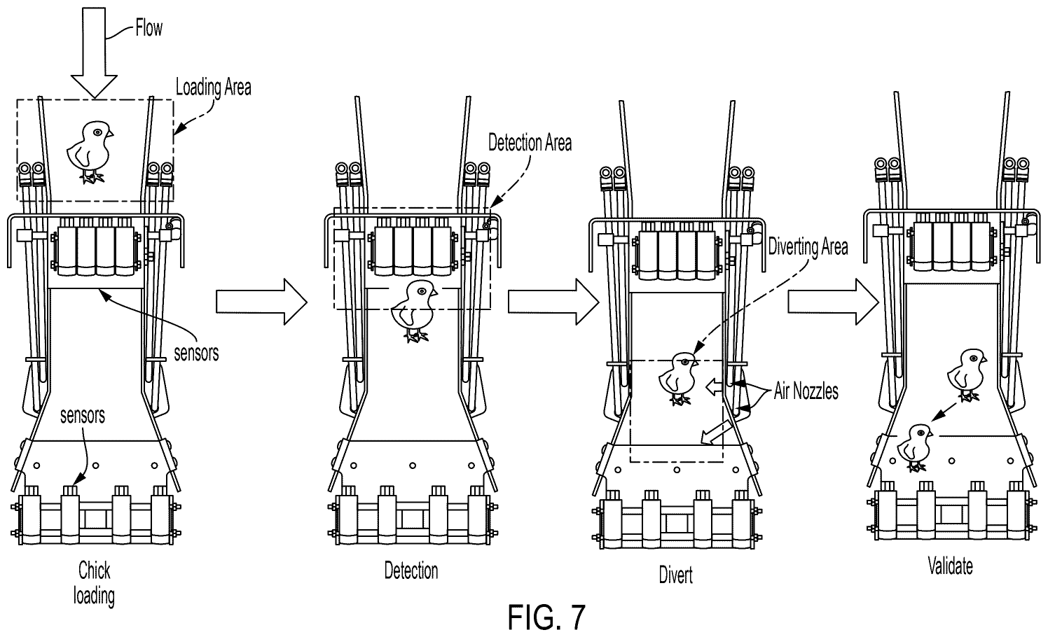

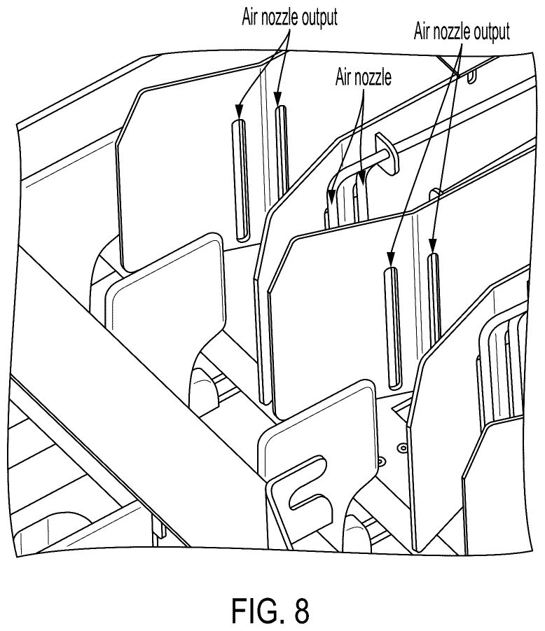

The input lanes are shown in FIGS. 5-6. As shown, the chick is received at the front portion of the input lane. The input lane has sensors configured to identify the chick and determine characteristics of the chick, which is discussed in more detail later in FIG. 7.

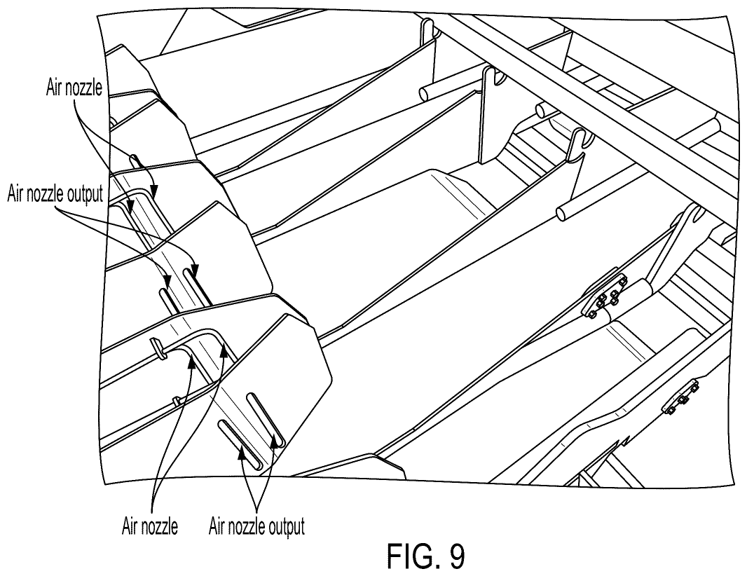

Further, as shown in FIGS. 5-6, the input lane includes air nozzles which deliver air through slots at the end of the lane to divert the chick to an output lane (not shown in FIGS. 5-6 but shown in FIGS. 3, 4 and 9).

The output lanes are shown in FIGS. 3, 4 and 9 where two output lanes correspond to each input lane so that the chick can be sorted to one of the output lanes after exiting the input lane. For example, a chick exits lane A and is diverted to either lane 4 or 5, a chick exits lane B and is diverted to either lane 3 or 4, a chick exits lane C and is diverted to either lane 2 or 3, and a chick exits lane D and is diverted to either lane 1 or 2. The air nozzles assist in this diversion process as explained below.

The moving platform may be a conveyor belt that is moving the chicks through the lanes in a straight line. In this regard, each lane is sized to receive a plurality of chicks in a single file line where the line is in the direction that the conveyor belt is moving.

The imaging sensors are positioned so that there is at least one imaging sensor per lane, according to one embodiment. It should be understood that one or more detectors (e.g., one or more cameras) may instead be used that monitors all lanes simultaneously and sends the relevant data to a processor for processing. The present invention should not be limited to each lane having its own sensor.

The conveyor belt moves to present the chicks proximate to respective imaging sensors (e.g., photoelectric sensors) to detect characteristics of the chicks, such as the size of each respective chick. The detected area of each chick is then converted to a “size” both area (2d) and volume (3d). The size then is used for a calculated duration of time to trigger valves to create an air flow for moving the chick.

The air nozzles are disposed at the end of the input lanes. Each lane may have two air nozzles on each side of each lane in one embodiment and may be positioned so that when a chick in a first lane, for example, enters a nozzle zone for the first lane, one air nozzle is configured to blow air from the first lane to a first direction (e.g., left) and another air nozzle is configured to blow air from the first lane to a second direction (e.g., right). As such, as the chick is conveyed down the conveyor, determined by both as a time-based calculation and position based, the air begins to flow as the chick enters the nozzle zone for the first lane and ends as the chick exits such nozzle zone. As mentioned above, in one embodiment, air nozzles are placed on the left and right side of the mechanism to divert the chick “left or right”. More air nozzles may also be put in place downstream for redundance.

Moreover, in some embodiments, the air nozzles may be a slot and air is constantly delivered along a vertical line towards the bird so that the full body of the chick receives the air to move the chick.

Additionally, there may be two or more air nozzles per side of each lane where the two nozzles delivers air on one side of the lane in two different directions to the other side of the lane, namely in a first direction perpendicular to the travel of belt and in a second direction that is at an angle greater than zero relative to the first direction, such as at an angle rotated at 20 degrees relative to the first direction.

Last, there may be a series of air nozzles applying air in the above-defined first direction along the length of the exit of the lane. In this regard, a series of nozzles can provide a series of air blasts that can be varied to divert different sizes and weights of chicks as they pass.

After the chick has been diverted in the first or second direction (e.g., left or right), an additional set of photoelectric sensors may validate (confirm) that the bird was diverted properly. This can be done by having two sets of sensors—a first set at the location where the bird was supposed to go and another set at a location where the bird was not supposed to go. If the first set of sensors recognizes the bird, the bird has been confirmed. On the other hand, if the second set of sensors recognizes the bird, the bird is not confirmed because the second set of sensors is monitoring an area or path where the bird is not intended to be directed to.

The chick diversion system also functions as a chick counter. Each chick that is passing through the system has the opportunity of being counted twice-once at initial detection before sorting and a second time at validation/confirmation.

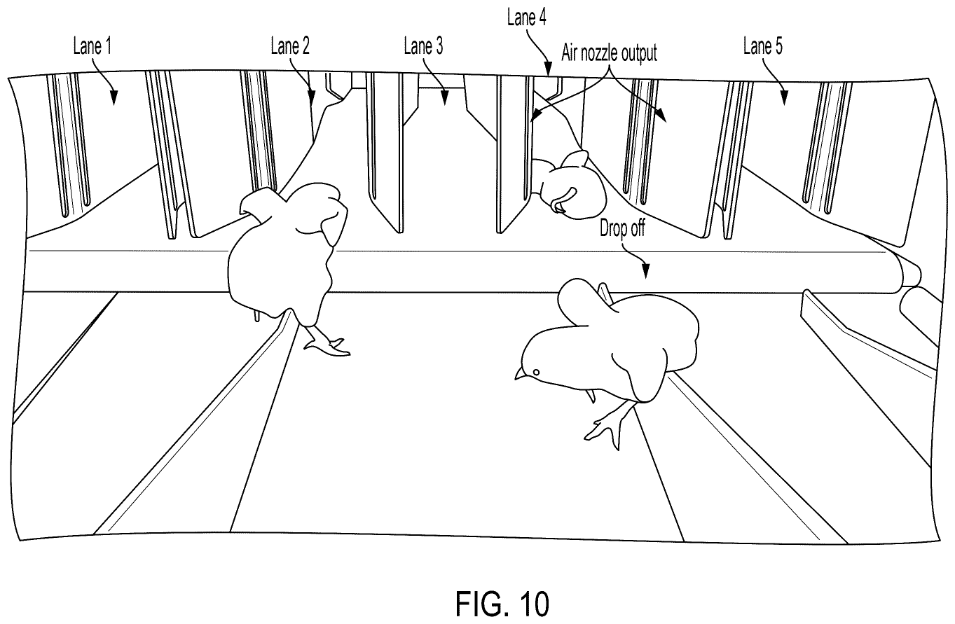

The chick can be diverted either on the conveyor belt, or during a drop between two conveyor belts (transition). In this regard, it should be noted that the air nozzles may blow air on a chick while the chick is in free fall (as the chick drops off from one transition surface to another) or may blow air on a chick just before such drop off or blow air on a chick while the chick is on a downwardly angled conveyor belt (which reduces the amount of friction or force between the chick and the surface supporting the chick). This is shown in FIGS. 3, 4 and 10.

The current diverting is using clean compressed air regulated between 40-50 psi. This value is also based on this specific valve performance and is based on previous testing. In this regard, any air nozzle and system that outputs 40-50 psi can be used in the present system. In another embodiment, any air nozzle and system can be employed where such air nozzle system is configured for applying pressure to a chick's surface area of approximately 50-120 cm² to generate sufficient force to move a 35-50 g chick onto the desired lane. The air pressure is such that it will not harm the chicks but moves the chicks effectively.

The system includes photo electric sensors which create: (1) a 3d space of chick and (2) background suppression (digital on/off area map). The system also includes a digital camera (area mapping) which uses infrared light spectrum, uses visible light spectrum (distinguishing between different colors or features of chicks), and/or uses monochrome (gradient light) (removing color and only focusing on gradient).

The system also includes 3d imaging which includes profiling camera (creating a 3d image of chicks for processing) and point cloud (creating a 3d image of chicks for processing).

The system also includes scales, including force gauge scales which measure the difference of weight.

The air nozzles may output any type of gas, including air nitrogen, oxygen, neon, hydrogen etc, or a combination of gases. In some embodiments, the air nozzles may be different types of output devices and may output liquids, solids or the like other than gas. For example, the nozzles may output water or other types of liquids. Moreover, one or more of the nozzles may have suction instead of blowing gas/liquids in order to divert the bird to one lane or the other.

In some embodiments, the air nozzles are designed to have air flow moving in a series of holes or slots defined in two directions—in a first direction perpendicular to the travel of belt and/or in a second direction that is at an angle greater than zero relative to the first direction, such as at an angle rotated at 20 degrees relative to the first direction.

A method of diverting the chicks will now be described in connection with FIG. 7.

First, the chick is loaded onto the conveyor belt in the loading area. The chicks may be fed into this area using another conveyor belt or disposed in this area in any manner.

Second, the chick is detected in the detection area where there are sensors that detect the size of the bird, the orientation of the bird, the location of the bird, the welfare of the bird, the gender of the bird, and any other characteristics of the bird. These are then used to determine the variables for diverting the chicks using the air nozzles, including the length of time the air nozzle is on, the air pressure to blow the chicks, when to turn the air nozzles on, etc.

These determined characteristics may also be used to determine which direction the bird is diverted to. For example, if the chick is determined to be a male, the system may divert the chick to the left lane versus if the chick is determined to be a female, the system may divert the chick to the right lane.

The speed of the belt is known and the position of the bird on the belt is known. Thus, the time it takes for the bird to get from the sensors to the diverting area where the air nozzles are located is known. As such, this time is fed to a controller that controls the air nozzles to determine when to turn on the air nozzle (i.e., so that it is not on when the bird is not at the diverting area.

As mentioned above, the variables for diverting the chicks using the air nozzles includes the length of time the air nozzle is on, the air pressure to blow the chicks, when to turn the air nozzles on, etc. For example, if the sensors determine the size of the bird is larger, the nozzles may be on longer, the air pressure may be increased, the nozzles are turned on for the whole time the chick is in the diverting area, and/or the like. This is because the bird may take more air and force to be diverted to the desired lane.

The air nozzles may use a single blast of gas/liquid or a series of blasts of gas/liquid to move the chicks. Moreover, the air nozzles may vary the length of time that the air nozzles are outputting pressurized air (40-50 psi for example).

In any event, in Step 3, the chick is diverted using the air nozzles using the variables and parameters discussed above.

In Step 4, the chick is then validated if it is in the correct path that the system determined for the chick using sensors associated with that path. The sensors over the path that is desired for the chick indicate whether the chick is within that path or not and sends signals to the system indicating that.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “has,” “have,” “having,” “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The explicit description of the present invention has been presented for purposes of illustration and description, but is not intended to be exhaustive or limited to embodiments of the invention in the form explicitly disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A system of diverting animals, the system comprising:
a series of lanes through with the animals are configured to be moved via at least one conveyer in a first direction;
at least one air diverter for each of the series of lanes, wherein a first air diverter of the at least one air diverter is associated with a first lane of the series of lanes and is configured to blow air on a first animal with a force to move the first animal horizontally to a first location in a second direction different from the first direction; and
a processor configured to detect the first animal traveling on a first conveyer at a position upstream of the first air diverter and to determine a timing for activating the first air diverter.

2. The system of claim 1, further comprising:
a second air diverter is associated with the first lane and is configured to blow air on the first animal with a force to move the animal horizontally to a second location in a third direction different from both the first and second directions.

3. The system of claim 2, wherein
the processor is configured to determine to activate either the first air diverter or the second air diverter but not both so that the animal is moved to the first location or the second location.

4. The system of claim 3, wherein
the first air diverter and the second air diverter are configured to be positioned at a predefined location at the first lane so that when the first animal reaches the predefined location, the first air diverter and the second air diverter are activated to move the first animal.

5. The system of claim 3, wherein the processor is configured to:
determine a gender of the animal;
move all animals that are determined to be male to the first location by activating the first diverter when each animal determined to be male reaches the first diverter; and
move all animals that are determined to be female to the second location by activating the second diverter when each animal determined to be female reaches the second diverter.

6. The system of claim 5, wherein the processor is configured to determine a gender of the animal by:
imaging the animal and processing the image to determine each animals gender.

7. The system of claim 2, wherein the air being blown by both the first wherein the first air diverter and second air diverter are each configured to generate a burst of air for less than 1 second, and wherein the first air diverter is configured to blow air in the first direction and the second air diverter is configured to blow air in the third direction.

8. The system of claim 1, wherein each lane comprises lane separators and the air diverters are configured to blow air through respective slots in the lane separators.

9. The system of claim 2, wherein the first location is a third land located upstream the first lane so that the first air diverter is configured to blow the animal from the first lane to the third lane, wherein the second location is a fourth lane located upstream the first lane so that the first air diverter is configured to blow the animal from the first lane to the third lane and so that the second air diverter is configured to blow the animal from the first lane to the fourth lane.

10. The system of claim 1, wherein the animals are chicks.

11. A method of diverting animals, the method comprising:
moving, via at least one conveyer, animals through a series of lanes in a first direction;
detecting, via a processor, a first animal traveling on a first conveyer at a position upstream of a first air diverter,
determining, via the processor, a timing for activating the first air diverter of the at least one air diverter, wherein the first air diverter is associated with a first lane of the series of lanes; and
blowing air on the first animal with a force to move the first animal horizontally to a first location in a second direction different from the first direction.

12. The method of claim 11, further comprising:
blowing air, using a second air diverter associated with the first lane, on the first animal with a force to move the first animal horizontally to a second location in a third direction different from both the first and second directions.

13. The method of claim 12, wherein
the processor is configured to determine to activate either the first air diverter or the second air diverter but not both so that the animal is moved to the first location or the second location.

14. The method of claim 13, wherein
the first air diverter and the second air diverter are configured to be positioned at a predefined location at the first lane so that when the first animal reaches the predefined location.

15. The method of claim 13, further comprising:
determining a gender of the animal;
moving all animals that are determined to be male to the first location by activating the first diverter when each animal determined to be male reaches the first diverter; and
moving all animals that are determined to be female to the second location by activating the second diverter when each animal determined to be female reaches the second diverter.

16. The method of claim 12, wherein the air being blown by both the first wherein the first air diverter and second air diverter are each configured to generate a burst of air for less than 1 second, and wherein the first air diverter is configured to blow air in the first direction and the second air diverter is configured to blow air in the third direction.

17. The method of claim 12, wherein the first location is a third land located upstream the first lane so that the first air diverter is configured to blow the animal from the first lane to the third lane, wherein the second location is a fourth lane located upstream the first lane so that the first air diverter is configured to blow the animal from the first lane to the third lane and so that the second air diverter is configured to blow the animal from the first lane to the fourth lane.

18. A system of diverting one or more chicks, the system comprising:
a first diverter that is associated with a first lane, wherein the first lane is configured to move the first chick through the first lane in a first direction, and wherein the first diverter is configured to blow air on a first chick with a force to move the first chick horizontally to a first location in a second direction,
a second diverter associated with the first lane and is configured to blow air on the first chick with a force to move the first chick horizontally to a second location in a third direction; and
a processor configured to detect the first chick traveling on a first conveyer at a position upstream of the first and second diverters and to determine whether to activate the first diverter or the second diverter and to determine a timing for activating the first diverter or the second diverter.

19. The system of claim 18 wherein the system is configured to operate in a high-throughput manner to process a plurality of chicks back to back.

20. The system of claim 19 wherein the processor is configured to:
determine a gender of the first chick;
move all of the plurality of chicks that are determined to be male to the first location by activating the first diverter when each chick determined to be male reaches the first diverter; and
move all chicks that are determined to be female to the second location by activating the second diverter when each chick determined to be female reaches the second diverter.
